(19) United States
(12) Patent Application Publication
(10) Pub. No.: US 2004/0039633 A1
(43) Pub. Date: Feb. 26, 2004

(54) Generic coupon

(76) Inventor: Ronald Nicholson, Conshohocken, PA (US)

Correspondence Address: Ronald Nicholson, 152 West 4th Avenue, Conshohocken, PA, 19428-1603, US

(21) Appl. No.: 10/227,347

(22) Filed: Aug. 22, 2002

(51) Int. Cl. G06F 17/60

(52) U.S. Cl. 705/14; 283/51; 283/56

(57) ABSTRACT

A discount, special value, or “cents-off” advertising or promotion coupon that is generic in nature so as to permit its use with a number of disparate offerings, at the discretion of the customer or end-user; and a means for promotion, distribution, redemption and utilization of such coupons.

The coupon is not dedicated to any particular manufacturer, merchant, product, service, or offering. It may also have multiple possible redemption values. It is valid for a variety of offers that are usually separately-advertised. The coupon is applied under the terms of whatever offer is in effect at the time and place of its redemption.

Various devices for utilization of the coupon take advantage of its generic nature, and include retail sale of the coupons to end-users, using the coupons as premiums, and more efficient promotional devices utilizing fewer coupons and more display advertising space than similar devices using conventional coupons.

In addition, systems for specifying and/or updating the list of available applications of such coupons may be used to extend the application of the coupons and possibly generate additional income. A “cents-off,” savings, “special-offer,” or discount coupon that is generic, universal, general, or non-specific in application; and system for promotion, distribution, and redemption of such coupon(s).

### BACKGROUND OF THE INVENTION

This invention relates to coupon vehicles for providing a discounted price, merchandise, or some other related value upon presentation.

Definition:

A coupon is the tangible instrument used to induce a customer to patronize a business by entitling the customer to receive a commercial advantage.

Its purpose is advertisement and promotion.

Usually, a coupon is printed paper, but any device used for the purpose cited above may be considered a “coupon.”

A coupon may be a detachable portion of a larger instrument; however, the definition may also apply to separate instruments used as described above.

In the context of this patent description, the term “coupon” is intended to be general and all-inclusive within the parameters stated above defining its purpose and use.

Application:

It has been popular for coupons to be distributed by direct mail, point-of-sale displays, hand-outs, newspaper and magazine advertisements; printed on other products such as cash register receipts or restaurant placemats; and circulated through direct retail sale and by other means.

The public has become increasingly responsive to coupons, and improvements in coupons and similar methods for promoting merchants, products, and services have been actively sought.

### SUMMARY OF THE INVENTION

This invention provides a coupon that is more broad in scope and more universal in application than other coupons, in that it may be used for any of several offers, rather than only one or a few specific offers; and a system to utilize such coupon(s).

This invention is distinguished from similar coupon systems currently in use and prior art by employing a coupon simultaneously embodying the following specified features:

1. The invention provides a coupon that may be applied to a multiple number of merchants, rather than to only a particular merchant; and

2. The invention provides a coupon that may be applied to a number of manufacturers, rather than application to only a particular manufacturer; and

3. The invention provides a coupon that may be applied to a number of offerings, rather than specific application to only a particular product or service; and

4. The invention provides a coupon that may have several redeemable values, rather than one particular amount of discount or specific value.

Alternately stated, a generic coupon is one that does not specify any particular (1) merchant, (2) manufacturer, (3) offering, or (4) value.

The generic coupon described here is used in the same way as other coupons.

However, with this invention, the customer may choose where, when, and for what to use the coupon.

The coupon is then redeemed at any participating merchant for a valid current offer in effect at the time and place of presentation.

A variation of the generic coupon invention is one wherein a relative or specific value is specified (such as $1 savings per coupon or 10% discount on purchase price), but where the other specifications apply. This does not depart from the spirit of the invention, a coupon of non-dedicated application and usefulness.

The customer is informed of the applicable uses of the generic coupon by means of a list of offers which may accompany the coupons; notice at participating merchants; listings available via pre-recorded telephone announcements or over the internet; listings which may be distributed, publicly posted, or otherwise advertised separately; or by other means.

Because of the unique nature of the Generic Coupon, various systems designed to utilize it are likewise unique. Variations include (but are not limited to):

1. Special newsletters or flyers containing the names of merchants honoring the coupons and the offerings for which the coupons may be used. These newsletters may contain some coupons; but, since each coupon is generic in nature and can be used for any offering, fewer coupons need be printed than the number of offerings made. Even so, the customer may choose to use several coupons in order to avail himself of multiple instances of the same offering. This flexibility is not possible using a system based upon conventional coupons.

2. Promotional letters that may contain as few as a single coupon. The customer may apply each coupon to any of numerous offers. In this way, the Generic Coupon may be used as a premium, where conventional coupons are limited in application.

3. Through the use of Generic Coupons, an advertising brochure may be more economically printed, since fewer coupons need be printed to cover a given number of advertisers, and therefore a greater percentage of space may be sold for advertising. The size of each advertisement may be significantly smaller than the size of a coupon. Furthermore, this space may be printed on the reverse, doubling the effective advertising space without making any coupons mutually-exclusive.

4. Since the coupons are generic, there need be no wasted coupons. Since the customer can choose the application of every coupon, every coupon is usable. Therefore, coupons may be sold directly to the end-user in a medium much more efficient than other similar methods using conventional coupons.

This patent application is not intended to apply to coupons that may contain another combination of the specifications or requiring additional features.

One example of such a coupon is the “manufacturer's coupon,” which offers cents-off on specific products but does not specify a particular merchant.

Another example is the “store or merchant's coupon” that may specify a particular merchant, but is valid for several offers.

Such coupons not simultaneously embodying specifications 1, 2, and 3 are within public domain and are beyond the scope of this invention.

A further exception is a coupon which may be valid for different offers, but may require additional features (such as stamps or special endorsements), or which is limited to only a few specific applications and is narrow in scope.

The general-application, non-specific, or universal coupon which is the invention described in this patent application (and which we generally call the “generic coupon”) provides several benefits to the consumer, the participating merchants, and the publisher; over the specific, dedicated, traditional, conventional, or normal coupons currently in use (which we generally call “common coupon”).

Overview of benefits:

1. The generic coupon is easier to locate, identify, store, sort, carry, and otherwise utilize compared to the common coupon.

2. The generic coupon is applicable to more uses than the common coupon.

3. The generic coupon can promote multiple simultaneous and successive offers.

4. The customer can choose the offer for which the coupon is used.

5. The generic coupon may be produced in forms and quantities that are not directly dependent upon the offerings made.

6. Because generic coupons are identical, they are more economical to publish and more practical to sell.

These features combine to make the generic coupon more suitable to the task of advertising and promotion than the common coupon.

Until the present invention, there has not been a coupon system with these advantages.

### DETAILED DESCRIPTION OF USEFULNESS

In order to be patentable, an invention must be novel and useful. The following list specifies some features and benefits of the generic coupon, showing novel attributes providing increased usefulness over traditional coupon systems.

A. Benefits to the Customer:

1. Choice of offer: A generic coupon is valid for the offer of the customer's choosing. Therefore, every coupon is usable for the most desirable offer.

This is especially true where a small number of coupons is given out; for example, when a coupon is given as a premium or coupons are printed on the back of cash register receipts.

2. Repeated use of offer: The customer may choose to use several generic coupons in order to enable repeated use of one particular offer. This is not possible with common coupons, where distribution is predetermined.

3. Extended application: A common coupon expires when its offer expires. The generic coupon may be used for subsequent offers.

3a. The generic coupon may have an indefinite life.

3b. A generic coupon may be valid for future offers not known at the time the coupon was issued, or for offers for which it was never intended, such as when unsupported merchants independently choose to honor the coupon.

4. Easier extraction: When multiple common coupons are printed in a booklet or circular, a particular common coupon must be extracted for use.

It is often difficult to find the particular coupon among the several printed It is often difficult to remove the coupon because of its location, such as on the inside of a page containing several disparate coupon offers.

Since generic coupons are identical, the most convenient one may be used. Generic coupons can be printed together in one location, such as along the edge of the page. Therefore, generic coupons are easier to find and easier to remove.

5. Greater convenience of use: Common coupons must be sorted so that a specific coupon may be found. The customer must carry more coupons or carefully plan in advance. Common coupons are troublesome to use.

One illustration of this fact is the various holders, carriers, and organizers that are manufactured to help the customer store and sort coupons. Another indication is the existence of groups of consumers organized to trade coupons.

Only a few generic coupons need be carried, since each has universal application. No sorting or exchanging is necessary. Generic coupons have an extended life. There is less need to weed out and replace expired coupons.

6. Easier to obtain: Identical generic coupons may be sold in retail packages. The customer may purchase coupons on demand. He or she may use generic coupons from other sources. This provides the customer with direct control over coupon availability and use. Such control is not practical with common coupons.

B. Benefits to the Participating Merchant:

The advantages to the customer, as specified above, make the generic coupon more viable, and therefore more profitable, as an advertising and promotional tool for the merchant. Further benefits follow:

1. Greater effectiveness: When coupons are distributed in small quantities, such as those printed on the back of cash register receipts or given singly as premiums, only a small portion of the customers will get one valid for any particular merchant's offer.

For example, there may be ten participating merchants in a promotion. If one coupon is given at random to each customer, only one customer in ten will get a particular merchant's coupon. The others will get coupons from other merchants.

Because neither the individual merchant nor the customer has any control over coupon distribution or application, most common coupons will be given to customers who do not wish to avail themselves of the particular offers to which they are entitled.

When generic coupons are distributed, the customer may choose the offer. The element of chance is eliminated. Every participating merchant gets a coupon good for its offer into the hands of every customer.

2. Ease of use: The generic coupons are easier to find, remove, and use. Easier redemption increases the return for the merchant.

3. Synergy: The participating merchants benefit from generic coupons obtained elsewhere, such as those distributed as premiums, those purchased directly, those in previous or subsequent editions of a promotional vehicle, those published in other vehicles, or made available through other means.

4. Indefinite shelf life: Generic coupons are always the same. There is no specific offer or critical expiration date, as with common coupons. The supermarket or distributor benefits from:

4a. Ability to maintain an adequate supply in depth;

4b. Reduced or eliminated waste;

4c. No inventory control problems;

4d. No need to return or exchange out-of-date stock.

5. More control: Because the generic coupon is non-specific, the merchant may change its offering at any time, while still utilizing any coupons in circulation, and therefore without any loss in advertising expense or customer good will.

6. Easier validation: The generic coupon is always good for the current offer. The merchant does not need to check expiration dates or application of the coupon. Labor and errors associated with validating normal coupons are eliminated.

6a. There is reduced customer embarrassment or ill will with generic coupons, compared to common coupons, when presented for an expired offer. Common coupons must be dishonored. Generic coupons can be applied to a current offer.

7. Application rollover: Normal coupon offers are restricted to a specific time period, to induce the customer into prompt action. When the offer expires, the merchant must print and distribute new coupons to replace those out of date.

There is the same psychological sense of urgency with generic coupons, since the offer is still dated and will expire in a short time. However, the generic coupon remains applicable for the next offering.

8. Less expensive: When common coupons are distributed independently, the return is small. Only few of the coupons go to customers who want them.

Generic coupons are typically distributed in larger quantities to a larger number of customers, with cost shared by several merchants. Each customer chooses the application of his or her generic coupon. The promotion is self-distributing.

Each merchant gets a coupon valid for its offering to more potential users, for about the same cost as a smaller independent mailing of common coupons.

8a. Additional merchants may purchase only small listings in the promotion. These merchants benefit from all generic coupons distributed, but pay a reduced price to participate. This is not possible with common coupons.

C. Advantages to the Publisher:

The advantages listed above make the generic coupon easier for the publisher to sell. Additional benefits are listed below:

1. Overlapping application: There is no one-to-one relationship required between the offerings presented and the number of generic coupons distributed in any instrument. All merchants share the same generic coupons.

Generic coupons may be given out singly or distributed in small numbers with multiple application. This is not possible with common coupons.

2. Simultaneous application: When generic coupons are distributed as random premiums, such as those printed on the back of cash register receipts, each participating merchant is a potential recipient of every coupon.

Fewer coupons need to be printed, may be sold for a greater price, may be sold simultaneously to several merchants, or may be sold more easily.

3. Retail sale: Direct sale of generic coupons to the customer is a viable possibility. This is not the case with common coupons, where ever-changing coupons, short life, restocking and exchange, and waste in expired coupons make it not practical to do so.

4. Smaller size: In a traditional multiple-offering advertising instrument, each coupon offer must be on the coupon, itself. There must be a coupon for every offer, even though the average customer will respond to only a few offers.

With generic coupons, only a few coupons need be printed, and each offer may be significantly smaller than a coupon and printed elsewhere on the document.

It is undesirable to print coupons back-to-back on both sides of a printed page. Two coupons printed thusly would be mutually-exclusive. With generic coupons, less space is subject to this restriction, because fewer coupons are printed.

4a. Because fewer coupons are printed, there is more space for offer listings.

4b. Because the listings are small, more listings can be printed.

4c. Because listings can be printed back-to-back on both sides of the instrument, the usable space for such listings is effectively doubled.

Listings may be sold at reduced rates not practical with common coupons. These advantages combine to make the printing of generic coupons more efficient, more effective, more economical, and therefore more profitable.

D. Advantages in a Hybrid Application:

The generic coupon provides additional advantages when used in conjunction with common coupons in a hybrid instrument.

In this configuration, there are common coupons printed for display advertisers. In addition, there are one or more generic coupons included in the publication.

Each merchant benefits from the generic coupon(s), while retaining the visibility and exclusivity of a common coupon.

Generic coupons may be valid for offers different from those of the common coupon(s). This allows the merchant to benefit from generic coupons while limiting another offer via a common coupon.

### DISCUSSION OF PRIOR ART

I have not been able to locate a patent for the common coupon. I believe that the coupon predates the patent system or is otherwise in the public domain.

I have found no true subclass or new type of coupon. No generic coupon or simple coupon designed to have a broad or universal application was found.

There is prior art under the classification 283 (Printed Matter), subclasses 56 (Advertising) and 117 (Miscellaneous); and elsewhere.

I have found patents relating to coupons or coupon schemes where a coupon is hidden, limited, complicated, made mutually-exclusive, or otherwise restricted; and various systems for the publication, distribution, sorting, storage, display, or processing of coupons. Two examples are:

U.S. Pat. No. 4,195,864, “Multi-Product Coupon,” which is a system whereby special stamps (which specify particular products) must be affixed to the coupon; and

U.S. Pat. No. 4,817,990, “Multiple Value Coupon System,” wherein the customer may choose one of a pair of coupons from two competitive sponsors.

Other similar inventions containing published or printed matter for a specific purpose have been patented. Examples are the credit card, lottery ticket, medical record card, a printed device to protect against unauthorized photocopying, etc.

Printed matter alone is not patentable. It is not my intention to patent printed matter. The invention described herein is a tangible device that has in part a printed portion. The device, not the printed portion, alone, is the invention.

A different style or format for doing something in public domain is patentable.

An example is the shirt pocket card, U.S. Pat. No. 4,968,065, which is nothing more than a piece of notepaper, but of a particular form which makes it more suitable to a specific task; namely, storage in a shirt pocket.

The purpose of any coupon is advertising and promotion. The generic coupon embodies features that make it easier to use, usable for more offers, for a longer time. It is more suitable to the task of advertising than common coupons.

The generic coupon may be considered to have a new and expanded purpose compared to traditional coupons, in much the same way as a credit card is a more universal application of a letter of credit.

The generic coupon is more useful than common coupons because it is designed to be broadly applicable rather than specific and limited in usefulness.

If the generic coupon were either obvious or mundane, it would be in use by this late date. The fact that it is not, although the coupon advertising field is extremely competitive, and in view of the generic coupon's many advantages; is indication of the generic coupon's latent and novel nature.

Coupons previously have been designed to limit the entitlement. The generic coupon is specifically designed to broaden the entitlement. In this regard, the generic coupon is fundamentally different from other coupons extant.

Furthermore, the generic coupon meets all three tests for “unobviousness” as per 383 U.S.1, 148 USPO 459 (1966); MPEP 2141:

1. Commercial success (achievable through the multiple competitive advantages declared above).

2. Long-felt but unsolved need (for example, the creation of a coupon which does not need to be replaced in circulation after its offer expires, a coupon which is self-distributing [see B8, above], a coupon which can be marketed to several advertisers simultaneously, etc.).

3. Failure of others (obvious, demonstrated through its heretofore non-existence). This, despite the advantages cited and lack of another means of achieving them.

A way of doing business is not patentable. It is not this inventor's intent to patent the idea of advertising, coupons in general, or way of doing business.

The generic coupon is a specific tangible device that facilitates advertising and promotion. This device, not any means of doing business, is the invention.

An example of this is a membership or entitlement card that entitles the bearer to the same type of trade considerations as does the generic coupon. The method of doing business is essentially the same, but the device is different.

The generic coupon is distinguished from membership cards in the same manner that coupons are distinguished from identification cards, generally:

Coupons are intended for short term or one time use, while membership cards identify the bearer as having long term, permanent, or continuous status.

Coupons allow offers to be run on a short-term basis, changed frequently, and discontinued easily.

Entitlement cards usually commit the merchant to longer participation (the term of the card) and often require a standard, non-changeable offer, such as a fixed discount rate.

Coupons generally can't be used repeatedly. They are constantly being printed and distributed for long-term advertising and promotion to maintain in effect.

As a result, they offer more flexibility compared to other devices, and therefore afford more control over the concession or other inducement offered to the customer and the redemption process.

The revenue generated from sale of coupons is proportional to coupon use. Coupons allow advertising and promotion to be marketed on the basis of quantitative results.

Coupons may be sold over time at a low incremental rate; for example, in the form of a series of promotions.

Entitlement cards are usually not marketed on the basis of degree of use; and when they are, some equipment or device, such as magnetic coding, bar codes, computer systems, punch-out boxes, or other means, is required to monitor the amount of use.

Coupons function as receipts when exchanged for the commercial advantage. Therefore, they are inherently self-tracking without any additional features or devices, and without requiring any extraordinary effort or additional equipment.

Coupons are created specifically for enabling the customer to a market concession for the purpose of advertising and promotion. The coupon needs no umbrella organization or other larger purpose to subsidize its operation. Often, advertising and promotion is a side benefit or incidental use of an entitlement card, and not a true measure of the card's design, purpose, or use.

An example of this is a credit card which may temporarily, incidentally, or additionally be used for discounts or other advantage to the customer, as a promotion of the credit system or an inducement to the customer.

In this example, the principal design, purpose, and use of the credit card is not advertising, but loans.

Coupons are available to everyone, without additional restrictions or qualifications, such as credit approval.

The generic coupon is distinguished from bonus stamps, or other redemption systems (such as campaigns where supermarket cash register receipts totaling a certain amount may be redeemed for some offer) in that generic coupons need not be accumulated or converted into anything else in order to be used.

The generic coupon is distinguished from currency or “money” in that:

1, its uses are restricted and not absolutely universal;

2, it is used for advertisement and promotion, not for trade or barter;

3, it usually has a defined term of life, longer than the offers, but still absolute;

4, it is restricted in the ways, terms, and conditions under which it may be used;

5, it has no absolute value in application, but varies according to how it is used;

6, it has no actual value over that of its construction materials;

7, it cannot be exchanged for real currency or money; and

8, it is not represented to be real money.

To the best of my knowledge and belief, I maintain this invention to be specified by definitions which are of a generally acceptable type, and that it is properly disclosed within the parameters for a patentable invention and is conforming to all requirements thereof.

### Illustrations

Listing of Illustrations:

Illustration 1a shows a common merchant's coupon.

Illustration 1b shows a common manufacturer's coupon.

Illustration 2 shows a generic coupon.

Illustration 3 shows a package of multiple coupons for retail sale.

Illustration 4 shows a hybrid publication containing generic coupons.

Listing of Reference Numerals:

1. Merchant

2. Manufacturer

3. Product

4. Discount or value

5. Expiration date

6. Title

7. Instructions

8. Strip of coupons

9. Generic coupon

10. Hybrid publication

11. Common coupon

12. Offer listings

13. Display advertising

Description:

The extended and additional utility of the generic coupon invention over the conventional coupon commonly in use today is a result of restrictive elements of the common coupon that have been eliminated or expanded.

For this reason, representations of both common coupons and a generic coupon are shown as illustrations 1 and 2.

Proper names used in the illustrations are fictitious examples and are for illustrative purposes, only; and not intended to limit the generic coupon invention specification.

Illustrations 3 and 4 represent two possible applications of generic coupons.

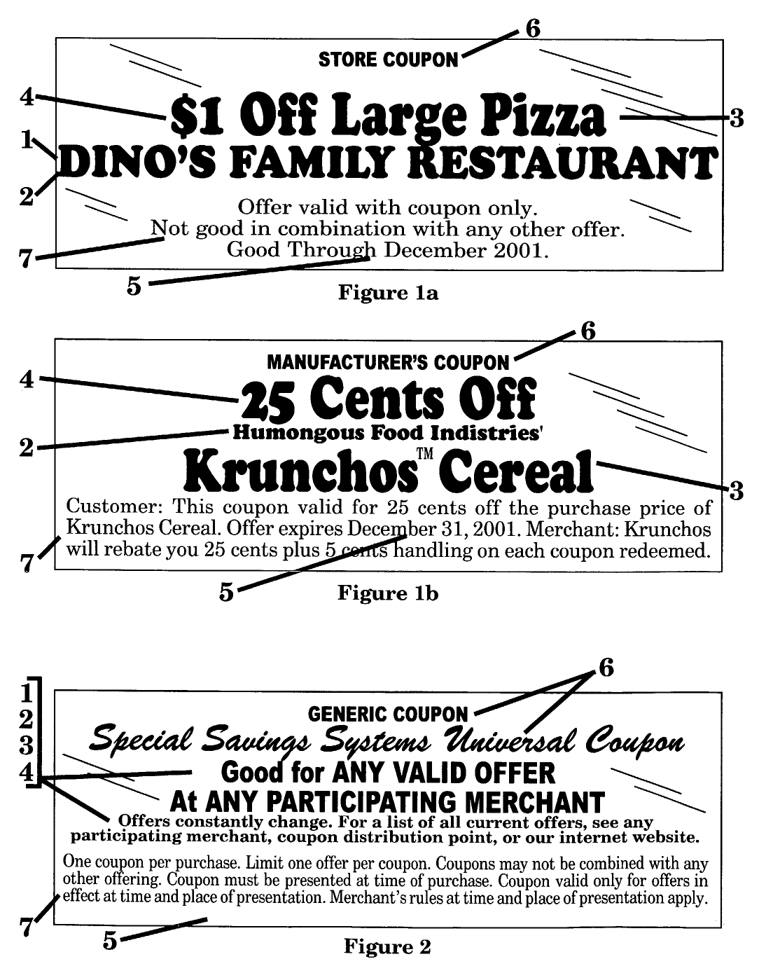

FIG. 1 is a representation of two typical common coupons, shown for comparative purposes.

FIG. 1a is a merchant's coupon.

FIG. 1b is a manufacturer's coupon.

FIG. 2 is a representation of the generic coupon.

A coupon is often printed paper, cover stock, or cardboard, rectangular in shape and close in size to (slightly larger than) a standard business card. However, coupons are made of different materials, in different shapes and sizes. Size, shape, materials, or construction are not critical to the usefulness of the coupon, and are not limiting factors in the definition or usefulness of the coupon.

A coupon consists of some suitable substrate, preferably inexpensive (for example, paper), containing identifying indicia (such as printed information). It is these indicia that most significantly define the purpose, intent, usefulness, and suitability to task of the invention.

The numbered features of the coupon indicia are as follows:

1. Identification of merchant. The merchant is the business or other entity offering the trade consideration, and where the coupon may be redeemed.

2. Identification of the manufacturer of products or services offered.

3. Identification of the product, service, or offering for which the coupon is valid.

4. Some specific or relative value for which the coupon is valid.

5. Expiration date of the offering or trade consideration, or of the coupon, itself.

6. Title or name of the coupon. This identifies the manufacturer or publisher of the coupon and/or identifies the instrument as a coupon.

7. Instructions and terms or conditions for use of the coupon.

All or most of the above are features of coupons of the type commonly in use.

The generic coupon is distinguished from prior art by the simultaneous improvement through broadened application of 1, 2, and 3.

Usually and ideally, 4 and 5 are also expanded in application, but this is not an absolute requirement of the generic coupon invention.

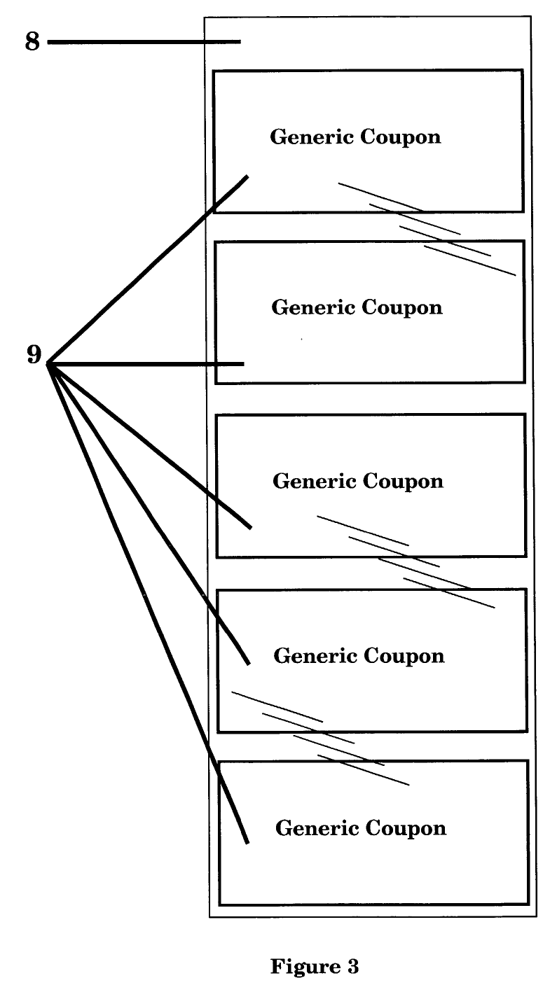

FIG. 3 represents one manifestation of claim 9, above:

“9. A combination of generic coupons in a booklet, strip, packaging, or other grouping, including singly, so as to be marketed directly to the consumer.”

Here, at least one generic coupon (9) is printed on a sheet (8) for sale to the general public. One or more such sheets may be combined in a package.

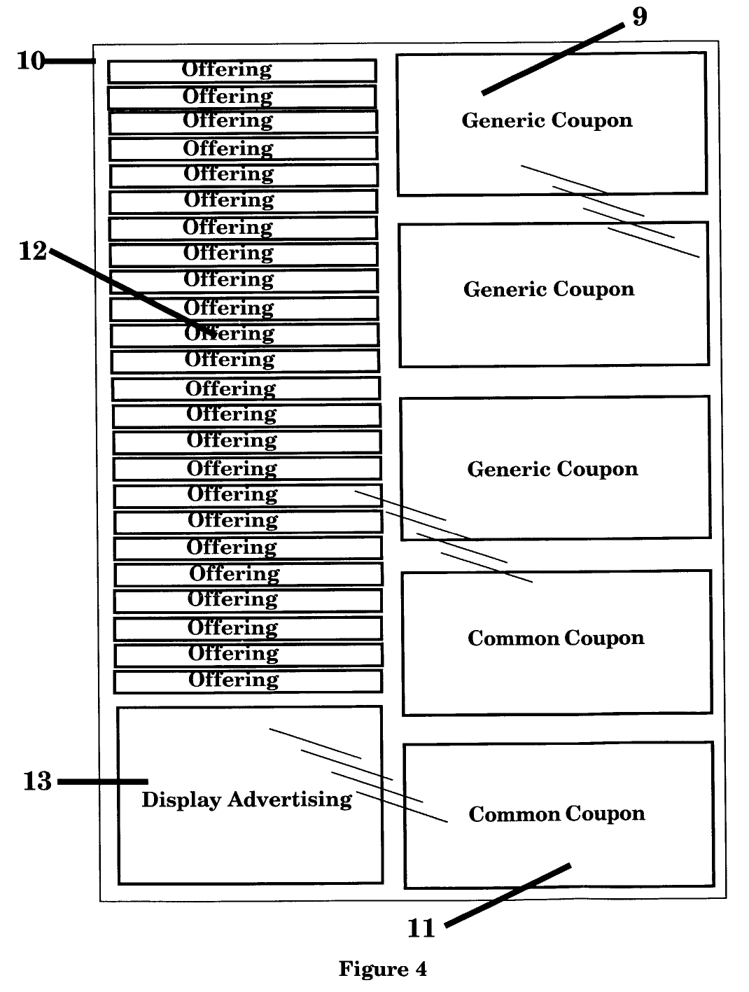

FIG. 4 represents one manifestation of claim 10, above:

“10. An advertisement and promotion vehicle containing advertisements of specific offers for which generic coupons may be valid, in combination with at least one generic coupon, where the vehicle may contain one or more common coupons.”

In this configuration, one or more generic coupons (9) are combined with other conventional advertising in a hybrid vehicle (10).

Such conventional advertising may include one or more common coupons (11).

Additionally, small advertisements of offerings for which the generic coupons are valid (12) may appear. These offerings may be smaller than the coupons, so that more offerings may be made within a given printed space.

Display advertising (13) may also be included. Such advertising may be used to promote the use of generic coupons, common coupons, and/or offers which do not require coupons; or for general advertising.

Additional similar advertising (not shown) may be printed on the reverse side of the page, behind the advertising on the obverse. Because of the nature of generic coupons, fewer of them need to be printed on the sheet. Therefore, there is more space for advertising copy, and this copy can be printed back-to-back without making any coupon mutually-exclusive with another.

I claim (generic or independent claim):

1. A coupon, ticket, or vehicle or instrument of advertising and promotion, entitling a customer, person, organization, corporation, or other entity bearing said coupon to receive a reduced price, refund or rebate, merchandise, services, or other preferential treatment or consideration; in order to induce that entity to patronize a merchant, purchase a product or service, or engage in other trade or commercial involvement or other activity; or any such device or instrument which is within commonly understood and generally held definition of “coupon;”
Where such coupon is distinguished from all previous coupons and the state-of-art in general by simultaneously embodying the following features:
(1) having multiple applicable merchants or no specific applicable merchant;
(2) having multiple applicable manufacturers or no specific manufacturer;
(3) having multiple offerings or no specific offering;
and (optionally) may also have one or both of the following:
(4) having multiple redemption values or no specific redemption value;
(5) having an extended or unlimited life;
thus providing a more universal, more broad, and more economical application, production, and distribution than is possible with common, or traditional, coupons of the type currently in use.
In addition, I claim the following variations, specific applications, and embodiments (specific or dependent claims):

2. A coupon made of paper, card or cover stock, plastic, fabric, sheet metal, wood, organic matter, or other similar printable or markable material which may be presented in exchange for goods, services, or other trade considerations, as an inducement for the bearer to patronize a business or purchase a product or service; where such coupon may be printed or otherwise marked with instructions for use and/or coupon company or trade name or other identification and/or possible applications; but where such coupon is applicable to multiple manufacturers, products, merchants, offerings, and trade considerations.

3. A generic coupon in which the multiple products, manufacturers, merchants, offerings, and trade considerations are specified elsewhere.

4. A generic coupon in which one or more of the multiple products, manufacturers, merchants, offerings, and trade considerations are specified on the coupon, itself.

5. A generic coupon that may additionally have multiple redemption values (dependent upon the offer selected by the customer).

6. A generic coupon which is attached to, included in, or combined with a letter; circular; other promotional, advertising, or general notice; or other such instrument; so as to increase the instrument's effectiveness and value.

7. A generic coupon which is printed as part of, or in combination with, another vehicle or device, such as on a cash register receipt or as part of a restaurant placemat; for the purpose of increasing the other vehicle's value or effectiveness.

8. A generic coupon used as a sample, premium, bonus, or award.

9. A combination of generic coupons in a booklet, strip, packaging, or other grouping, including singly, so as to be marketed directly to the consumer.

10. A promotional vehicle containing advertisements of specific offers for which generic coupons may be valid, in combination with at least one generic coupon, where the vehicle may optionally contain one or more common coupons.

11. A system utilizing the generic coupon, wherein the applications of the coupon are posted publicly and/or published in a newspaper, newsletter, magazine, or other publication (available by subscription or otherwise).

12. A system utilizing the generic coupon, wherein the applications of the coupon are made available to the public and/or updated by means of voice communication, such as a recorded telephone message.

13. A system utilizing the generic coupon, wherein the applications of the coupon are made available to the public and/or updated by means of electronic communication, such as via a computer bulletin board or internet site.
